(19) United States
(12) Patent Application Publication
(10) Pub. No.: US 2025/0349055 A1
(43) Pub. Date: Nov. 13, 2025

(54) METHODS, APPARATUSES AND COMPUTER PROGRAM PRODUCTS FOR PROVIDING GENERALIZED STYLIZED PICTURES

(71) Applicant: META PLATFORMS, INC., Menlo Park, CA (US)

(72) Inventors: Trev Poulson, Costa Mesa, CA (US); Breanne Miller, Seattle, WA (US)

(21) Appl. No.: 19/203,489

(22) Filed: May 9, 2025

Related U.S. Application Data
(60) Provisional application No. 63/644,778, filed on May 9, 2024.

(51) Int. Cl. G06T 11/60

(52) U.S. Cl. CPC G06T 11/60; G06T 2200/24

(57) ABSTRACT

A system and method to generate artificial intelligence (AI) images are provided. The system may analyze a first image including visual content indicating a user(s). The system may implement a machine learning (ML) model including training data trained on images associated with genres, categories, styles and/or themes. The system may generate, by implementing the ML model, a first AI image(s) of the first user(s), including an AI style, associated with the first image. The system may generate a first user interface including the first AI image(s) of the first user(s). The first user interface may include indicia to enable a second user(s) to mimic the AI style of the first AI image(s) to apply to a second image including visual data indicating the second user(s) to generate a second AI image(s) associated with the second user(s).

### CROSS-REFERENCE TO RELATED APPLICATIONS

This application claims priority to U.S. Provisional Application No. 63/644,778, filed May 9, 2024, entitled, “Generalized Stylized Profile Pictures,” the contents of which is incorporated by reference herein in its entirety.

### TECHNOLOGICAL FIELD

Examples of the present disclosure may relate generally to methods, apparatuses and computer program products to generate and/or provide artificial intelligence (AI) generated stylized images of users associated with a platform, network, system, or the like.

### BACKGROUND

Some existing systems may lack techniques to allow users to express themselves creatively to stylize profile photos of the users associated with the system(s). For instance, some existing systems lack a robust approach to allow users of the system(s) to accurately represent themselves with regards to augmenting images of profile photos of the users. Such lack of creativity to augment profile photos of users may result in undesirable user experiences associated with a system and may make users feel that interaction with the system(s) is cumbersome and burdensome since the users desired likeness may not be represented. In some instances, this may undesirably minimize users interaction and engagement with the system(s).

As such, it may be beneficial to provide efficient and reliable mechanisms that provide improvement to the creation of AI images of users to enhance user experiences associated with a system and/or network.

### BRIEF SUMMARY

Some examples of the present disclosure may provide techniques and mechanisms to facilitate the use of machine learning (ML) and/or AI to generate AI stylized photos, images and/or the like of users associated with a platform, network, system and/or the like. In some examples, the photos, images and/or the like may, but need not, be profile photos/pictures/images of one or more users associated with a platform, network, system and/or the like. In other examples the photos, images, pictures and/or the like may be any suitable photos, images, pictures and/or the like of users associated with a platform, network, system, and/or the like.

By utilizing the exemplary aspects of the present disclosure, users may invoke or select a prompt (e.g., an input prompt), or click/select a button(s), icon, or the like to trigger generation of an AI image, AI photo, or AI picture (e.g., an AI profile picture) of the user generated based on a current photo (e.g., a current profile picture/photo) of the user, and/or an uploaded image of the user. The triggered generation of the AI image may be in a specific personalized/tailored manner and/or a style(s) desired by the user. The new generated AI image/photo/picture (e.g., AI profile image), or the like may be saved, shared, and/or uploaded as a new photo (e.g., new profile photo) of a user associated with a platform, network, system, or the like.

Upon interaction with, and/or being presented with, the new AI photo, one or more other users of the platform, network, system, or the like may mimic (e.g., copy) the style of the new AI photo to generate an AI photo (e.g., an AI profile photo) of themselves in a similar style, similar theme and/or the like. In this manner, the exemplary aspects of the present disclosure may generate tailored and personalized AI style images, photos, pictures to users to utilize on, or associated with, a platform, network, system or the like.

By utilizing the exemplary aspects of the present disclosure, users may easily update their user profiles and user photos (e.g., profile photos, cover photos, etc.) to reflect their authentic selves. As such, the example aspects of the present disclosure may enable users to represent themselves in AI styles such that the users may be recognized, on a platform, network, system or like in the desired manner of the users, which may enhance interaction with the platform, network, system or the like since the users may be more inclined to utilize, and engage with the platform, network, system, or the like.

In one example of the present disclosure, a method is provided. The method may include analyzing a first image including visual content indicating a first user. The method may further include implementing a machine learning model including training data trained on one or more images associated with genres, categories, styles or themes. The method may further include generating, by implementing the machine learning model, a first artificial intelligence image of the first user, including an AI style, associated with the first image. The method may further include generating a first user interface including the artificial intelligence image of the first user. The first user interface may include indicia to enable a second user to mimic the artificial intelligence style of the first artificial intelligence image to apply to a second image including visual data indicating the second user to generate a second artificial intelligence image associated with the second user.

In another example of the present disclosure, an apparatus is provided. The apparatus may include one or more processors and a memory including computer program code instructions. The memory and computer program code instructions are configured to, with at least one of the processors, cause the apparatus to at least perform operations including analyzing a first image including visual content indicating a first user. The memory and computer program code are also configured to, with the processor(s), cause the apparatus to implement a machine learning model including training data trained on one or more images associated with genres, categories, styles or themes. The memory and computer program code are also configured to, with the processor(s), cause the apparatus to generate, by implementing the machine learning model, a first artificial intelligence image of the first user, including an artificial intelligence style, associated with the first image. The memory and computer program code are also configured to, with the processor(s), cause the apparatus to generate a first user interface including the artificial intelligence image of the first user. The first user interface may include indicia to enable a second user to mimic the artificial intelligence style of the first artificial intelligence image to apply to a second image including visual data indicating the second user to generate a second artificial intelligence image associated with the second user.

In yet another example of the present disclosure, a computer program product is provided. The computer program product may include at least one non-transitory computer-readable medium including computer-executable program code instructions stored therein. The computer-executable program code instructions may include program code instructions configured to analyze a first image including visual content indicating a first user. The computer-executable program code instructions may further include program code instructions configured to implement a machine learning model including training data trained on one or more images associated with genres, categories, styles or themes. The computer-executable program code instructions may further include program code instructions configured to generate, by implementing the machine learning model, a first artificial intelligence image of the first user, including an artificial intelligence style, associated with the first image. The computer-executable program code instructions may further include program code instructions configured to generate a first user interface including the artificial intelligence image of the first user. The first user interface may include indicia to enable a second user to mimic the artificial intelligence style of the first artificial intelligence image to apply to a second image including visual data indicating the second user to generate a second artificial intelligence image associated with the second user.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

A summary, as well as the following detailed description, is further understood when read in conjunction with the appended drawings. For the purpose of illustrating the disclosed subject matter, there are shown in the drawings exemplary embodiments of the disclosed subject matter; however, the disclosed subject matter is not limited to the specific methods, compositions, and devices disclosed. In addition, the drawings are not necessarily drawn to scale. In the drawings:

FIG. 1 is a diagram of an exemplary network environment in accordance with an example of the present disclosure.

FIG. 2 is a diagram of an exemplary communication device in accordance with an example of the present disclosure.

FIG. 3 is a diagram of an exemplary computing system in accordance with an example of the present disclosure.

FIG. 4A is a diagram illustrating an exemplary profile picture in accordance with exemplary aspects of the present disclosure.

FIG. 4B and FIG. 4C are diagrams illustrating exemplary user interfaces including AI generated images in AI styles in accordance with exemplary aspects of the present disclosure.

FIG. 4D, FIG. 4E and FIG. 4F are diagrams illustrating other exemplary user interfaces including AI generated images in AI styles in accordance with exemplary aspects of the present disclosure.

FIG. 5A, FIG. 5B, FIG. 5C and FIG. 5D are diagrams illustrating other exemplary user interfaces including AI generated images in AI styles in accordance with exemplary aspects of the present disclosure.

FIG. 6 is a diagram illustrating a plurality of AI styles to generate personalized AI stylized images in accordance with an example of the present disclosure.

FIG. 7, FIG. 8 and FIG. 9 are diagrams illustrating AI generated images having various AI styles in accordance with exemplary aspects of the present disclosure.

FIG. 10 is a diagram illustrating a manner in which to enter or input prompts within a user interface to generate one or more AI photo styles in accordance with an example of the present disclosure.

FIG. 11 illustrates an example of a machine learning framework in accordance with one or more examples of the present disclosure.

FIG. 12 illustrates an example flowchart illustrating operations to generate AI images in accordance with an example of the present disclosure.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein. Like reference numerals refer to like elements throughout. As used herein, the terms “data,” “content,” “information” and similar terms may be used interchangeably to refer to data capable of being transmitted, received and/or stored in accordance with embodiments of the invention. Moreover, the term “exemplary”, as used herein, is not provided to convey any qualitative assessment, but instead merely to convey an illustration of an example. Thus, use of any such terms should not be taken to limit the spirit and scope of embodiments of the invention.

As defined herein a “computer-readable storage medium,” which refers to a non-transitory, physical or tangible storage medium (e.g., volatile or non-volatile memory device), may be differentiated from a “computer-readable transmission medium,” which refers to an electromagnetic signal.

As referred to herein, a profile picture(s), profile image(s), profile photo(s) or the like may refer to an image (e.g., a digital image) that may be associated with a user(s) and/or an account (e.g., a platform, network or system account (e.g., a social network account)) of the user(s) the platform/network/system, or the like. The profile picture(s) may be associated with interactions of the user(s) across the platform/network/system, or the like. For purposes of illustration and not of limitation, for example, profile pictures may be presented/displayed in association with shared content, messages, posts, mentions, likes, comments, account names and other interactions across the platform/network/system, or the like.

As referred to herein, an AI style(s) may refer to one or more art characteristics and/or aesthetic attributes applied to an image(s) by utilizing artificial intelligence to generate an enhanced image(s). In some examples, the AI style(s) may include, or be associated with, an AI theme(s), which may be associated with a type(s), genre(s), or category of digital/enhanced art of an AI generated image(s).

It is to be understood that the methods and systems described herein are not limited to specific methods, specific components, or to particular implementations. It is also to be understood that the terminology used herein is for the purpose of describing particular embodiments only and is not intended to be limiting.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

Also, as used in the specification including the appended claims, the singular forms “a,” “an,” and “the” include the plural, and reference to a particular numerical value includes at least that particular value, unless the context clearly dictates otherwise. The term “plurality”, as used herein, means more than one. When a range of values is expressed, another embodiment includes from the one particular value or to the other particular value. Similarly, when values are expressed as approximations, by use of the antecedent “about,” it will be understood that the particular value forms another embodiment. All ranges are inclusive and combinable. It is to be understood that the terminology used herein is for the purpose of describing particular aspects only and is not intended to be limiting.

### Exemplary System Architecture

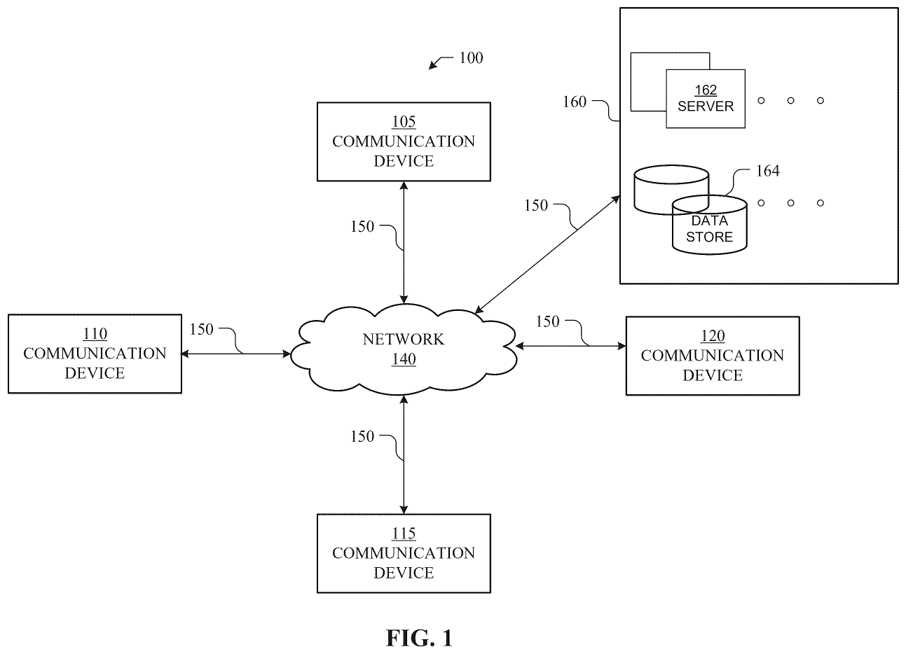

Reference is now made to FIG. 1, which is a block diagram of a system according to exemplary embodiments. As shown in FIG. 1, the system 100 may include one or more communication devices 105, 110, 115 and 120 and a network device 160. Additionally, the system 100 may include any suitable network such as, for example, network 140. In some examples, the network 140 may be a Metaverse network. In other examples, the network 140 may be any suitable network capable of provisioning content and/or facilitating communications among entities within or associated with the network. As an example and not by way of limitation, one or more portions of network 140 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 140 may include one or more networks 140.

Links 150 may connect the communication devices 105, 110, 115 and 120 to network 140, network device 160 and/or to each other. This disclosure contemplates any suitable links 150. In some exemplary embodiments, one or more links 150 may include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In some exemplary embodiments, one or more links 150 may each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 150, or a combination of two or more such links 150. Links 150 need not necessarily be the same throughout system 100. One or more first links 150 may differ in one or more respects from one or more second links 150.

In some exemplary embodiments, communication devices 105, 110, 115, 120 may be electronic devices including hardware, software, or embedded logic components or a combination of two or more such components and capable of carrying out the appropriate functionalities implemented or supported by the communication devices 105, 110, 115, 120. As an example, and not by way of limitation, the communication devices 105, 110, 115, 120 may be a computer system such as for example a desktop computer, notebook or laptop computer, netbook, a tablet computer (e.g., a smart tablet), e-book reader, Global Positioning System (GPS) device, camera, personal digital assistant (PDA), handheld electronic device, cellular telephone, smartphone, smart glasses, augmented/virtual reality device, smart watches, charging case, or any other suitable electronic device, or any suitable combination thereof. The communication devices 105, 110, 115, 120 may enable one or more users to access network 140. The communication devices 105, 110, 115, 120 may enable a user(s) to communicate with other users at other communication devices 105, 110, 115, 120.

Network device 160 may be accessed by the other components of system 100 either directly or via network 140. As an example, and not by way of limitation, communication devices 105, 110, 115, 120 may access network device 160 using a web browser or a native application associated with network device 160 (e.g., a mobile social-networking application, a messaging application, another suitable application, or any combination thereof) either directly or via network 140. In particular exemplary embodiments, network device 160 may include one or more servers 162. Each server 162 may be a unitary server or a distributed server spanning multiple computers or multiple datacenters. Servers 162 may be of various types, such as, for example and without limitation, web server, news server, mail server, message server, advertising server, file server, application server, exchange server, database server, proxy server, another server suitable for performing functions or processes described herein, or any combination thereof. In particular exemplary embodiments, each server 162 may include hardware, software, or embedded logic components or a combination of two or more such components for carrying out the appropriate functionalities implemented and/or supported by server 162. In particular exemplary embodiments, network device 160 may include one or more data stores 164. Data stores 164 may be used to store various types of information. In particular exemplary embodiments, the information stored in data stores 164 may be organized according to specific data structures. In particular exemplary embodiments, each data store 164 may be a relational, columnar, correlation, or other suitable database. Although this disclosure describes or illustrates particular types of databases, this disclosure contemplates any suitable types of databases. Particular exemplary embodiments may provide interfaces that enable communication devices 105, 110, 115, 120 and/or another system (e.g., a third-party system) to manage, retrieve, modify, add, or delete, the information stored in data store 164.

Network device 160 may provide users of the system 100 the ability to communicate and interact with other users. In particular exemplary embodiments, network device 160 may provide users with the ability to take actions on various types of items or objects, supported by network device 160. In particular exemplary embodiments, network device 160 may be capable of linking a variety of entities. As an example, and not by way of limitation, network device 160 may enable users to interact with each other as well as receive content from other systems (e.g., third-party systems) or other entities, or to allow users to interact with these entities through an application programming interfaces (API) or other communication channels.

It should be pointed out that although FIG. 1 shows one network device 160 and four communication devices 105, 110, 115 and 120, any suitable number of network devices 160 and communication devices 105, 110, 115 and 120 may be part of the system of FIG. 1 without departing from the spirit and scope of the present disclosure.

### Exemplary Communication Device

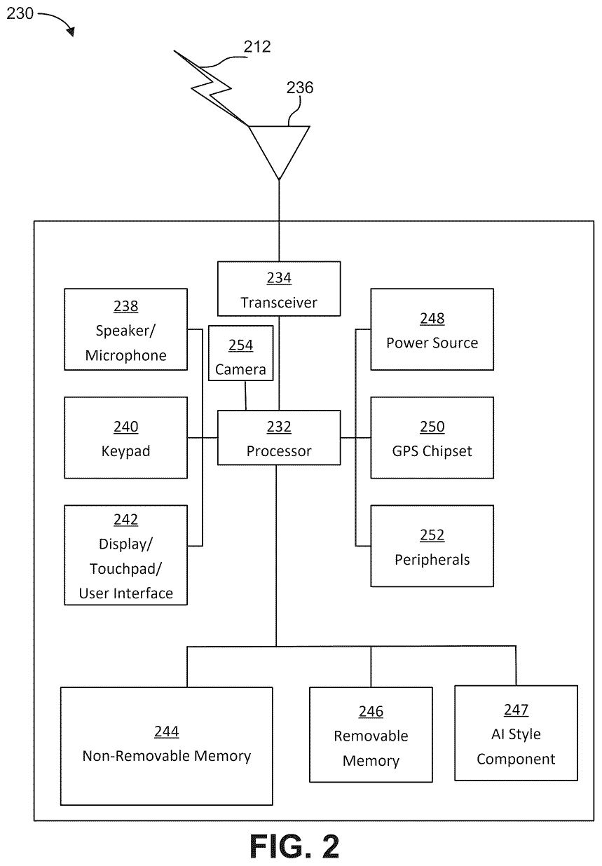

FIG. 2 illustrates a block diagram of an exemplary hardware/software architecture of a communication device such as, for example, user equipment (UE) 230. In some exemplary aspects, the UE 230 may be any of communication devices 105, 110, 115, 120. In some exemplary aspects, the UE 230 may be a computer system such as for example a desktop computer, notebook or laptop computer, netbook, a tablet computer (e.g., a smart tablet), e-book reader, GPS device, camera, personal digital assistant, handheld electronic device, cellular telephone, smartphone, smart glasses, augmented/virtual reality device, smart watch, charging case, or any other suitable electronic device. As shown in FIG. 2, the UE 230 (also referred to herein as node 230) may include a processor 232, non-removable memory 244, removable memory 246, a speaker/microphone 238, a keypad 240, a display, touchpad, and/or user interface(s) 242, a power source 248, a global positioning system (GPS) chipset 250, other peripherals 252, and an artificial intelligence (AI) style component 247. In some exemplary aspects, the display, touchpad, and/or user interface(s) 242 may be referred to herein as display/touchpad/user interface(s) 242. The display/touchpad/user interface(s) 242 may include a user interface capable of presenting one or more content items and/or capturing input of one or more user interactions/actions associated with the user interface. The power source 248 may be capable of receiving electric power for supplying electric power to the UE 230. For example, the power source 248 may include an alternating current to direct current (A C-to-DC) converter allowing the power source 248 to be connected/plugged to an AC electrical receptable and/or Universal Serial Bus (USB) port for receiving electric power. The UE 230 may also include a camera 254. In an exemplary embodiment, the camera 254 may be a smart camera configured to sense images/video appearing within one or more bounding boxes. The UE 230 may also include communication circuitry, such as a transceiver 234 and a transmit/receive element 236. It will be appreciated the UE 230 may include any sub-combination of the foregoing elements while remaining consistent with an embodiment.

The processor 232 may be a special purpose processor, a digital signal processor (DSP), a plurality of microprocessors, one or more microprocessors in association with a DSP core, a controller, a microcontroller, Application Specific Integrated Circuits (ASICs), Field Programmable Gate Array (FPGA s) circuits, any other type of integrated circuit (IC), a state machine, and the like. In general, the processor 232 may execute computer-executable instructions stored in the memory (e.g., non-removable memory 244 and/or removable memory 246) of the node 230 in order to perform the various required functions of the node. For example, the processor 232 may perform signal coding, data processing, power control, input/output processing, and/or any other functionality that enables the node 230 to operate in a wireless or wired environment. The processor 232 may run application-layer programs (e.g., browsers) and/or radio access-layer (RAN) programs and/or other communications programs. The processor 232 may also perform security operations such as authentication, security key agreement, and/or cryptographic operations, such as at the access-layer and/or application layer for example.

The processor 232 is coupled to its communication circuitry (e.g., transceiver 234 and transmit/receive element 236). The processor 232, through the execution of computer executable instructions, may control the communication circuitry in order to cause the node 230 to communicate with other nodes via the network to which it is connected.

The transmit/receive element 236 may be configured to transmit signals to, or receive signals from, other nodes or networking equipment. For example, in an exemplary embodiment, the transmit/receive element 236 may be an antenna configured to transmit and/or receive radio frequency (RF) signals. The transmit/receive element 236 may support various networks and air interfaces, such as wireless local area network (WLAN), wireless personal area network (WPAN), cellular, and the like. In yet another exemplary embodiment, the transmit/receive element 236 may be configured to transmit and/or receive both RF and light signals. It will be appreciated that the transmit/receive element 236 may be configured to transmit and/or receive any combination of wireless or wired signals.

The transceiver 234 may be configured to modulate the signals that are to be transmitted by the transmit/receive element 236 and to demodulate the signals that are received by the transmit/receive element 236. As noted above, the node 230 may have multi-mode capabilities. Thus, the transceiver 234 may include multiple transceivers for enabling the node 230 to communicate via multiple radio access technologies (RATs), such as universal terrestrial radio access (UTRA) and Institute of Electrical and Electronics Engineers (IEEE 802.11), for example.

The processor 232 may access information from, and store data in, any type of suitable memory, such as the non-removable memory 244 and/or the removable memory 246. For example, the processor 232 may store session context in its memory, (e.g., non-removable memory 244 and/or removable memory 246) as described above. The non-removable memory 244 may include RAM, ROM, a hard disk, or any other type of memory storage device. The removable memory 246 may include a subscriber identity module (SIM) card, a memory stick, a secure digital (SD) memory card, and the like. In other exemplary embodiments, the processor 232 may access information from, and store data in, memory that is not physically located on the node 230, such as on a server or a home computer.

The processor 232 may receive power from the power source 248 and may be configured to distribute and/or control the power to the other components in the node 230. The power source 248 may be any suitable device for powering the node 230. For example, the power source 248 may include one or more dry cell batteries (e.g., nickel-cadmium (NiCd), nickel-zinc (NiZn), nickel metal hydride (NIM H), lithium-ion (Li-ion), etc.), solar cells, fuel cells, and the like. The processor 232 may also be coupled to the GPS chipset 250, which may be configured to provide location information (e.g., longitude and latitude) regarding the current location of the node 230. It will be appreciated that the node 230 may acquire location information by way of any suitable location-determination method while remaining consistent with an exemplary embodiment.

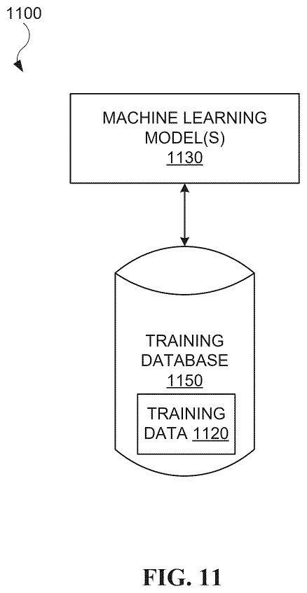

The UE 230 may also include an AI style component 247 that may include a machine learning model(s) (e.g., machine learning model(s) 1130 of FIG. 11) and/or an AI model(s) configured to generate one or more AI stylized images associated with a user(s). In some examples, the AI style component 247 may implement the machine learning model(s) (e.g., machine learning model(s) 1130) and/or the AI model(s) that may be pre-trained, and/or trained in real time with training data (e.g., training data 1120 of FIG. 11) to generate one or more AI stylized images, photos, pictures, or the like in a desired manner (e.g., a desired style) of a user(s) (e.g., a user of the UE 230, or other user) presented in a user interface tailored to the user(s), as described more fully below. In some examples, the AI style component 247 may, for example, in response to detection/determination of an input(s) (e.g., an input prompt(s)), button(s)/icon(s), capture of an audio instruction(s), or the like, or other trigger component, generate an AI image(s) (e.g., an AI profile image) of a user in a AI style based on a current image (e.g., a current profile image) of the user(s). The updated or newly generated AI image(s) may be saved, shared, uploaded, and/or the like as a new photo/image (e.g., a new user profile photo/image) associated with a platform, network (e.g., network 140), system (e.g., system 100), or the like.

In some examples, the AI style component 247 may enable one or more other users, for example when being presented with or interacting with the new generated AI image(s), to mimic (e.g., copy) the AI style of the newly generated AI image(s) such that the AI style may be applied by the AI style component 247 to an image(s), photo(s), picture(s), or the like (e.g., a profile image/picture) of one or more of the other users, as described more fully below. In this manner, the AI style component 247 may generate a new/updated image(s) of the one or more other users in a same AI style of the new generated AI image(s).

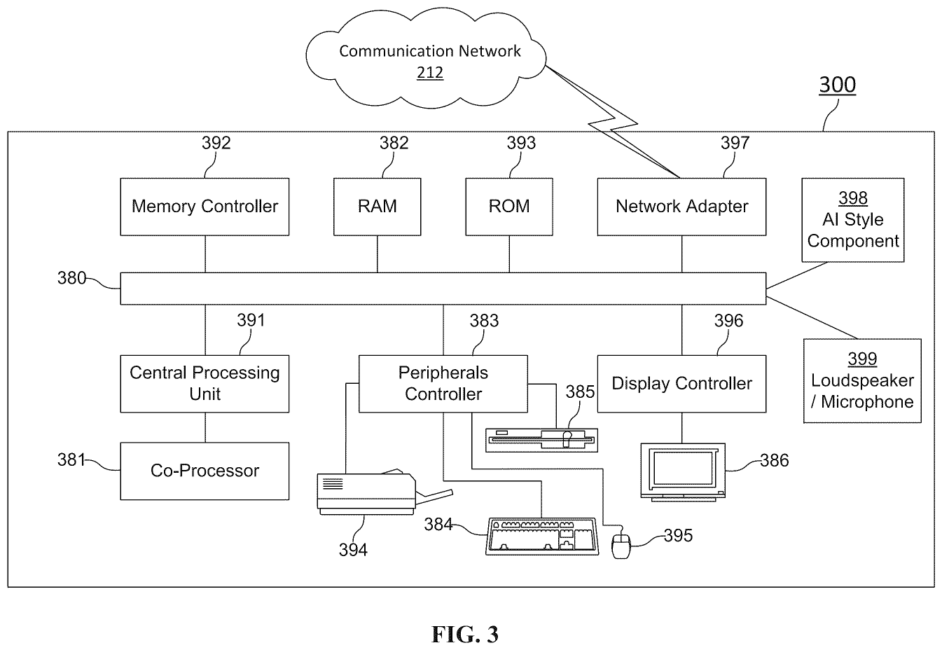

In some examples, the AI style component 247 may provide/present one or more generated AI style images, photos, pictures, or the like and one or more personalized user interfaces to the display, touchpad, and/or the user interface(s) 242 for presentation by the UE 230. In some other examples, the AI style component 247 may provide the generated AI style images, photos, pictures and/or the one or more personalized user interfaces to one or more communication devices (e.g., other UEs 230) and/or other devices (e.g., computing system 300 of FIG. 3).

### Exemplary Computing System

FIG. 3 is a block diagram of an exemplary computing system 300. In some exemplary embodiments, the network device 160 may be a computing system 300. The computing system 300 may comprise a computer or server and may be controlled primarily by computer readable instructions, which may be in the form of software, wherever, or by whatever means such software is stored or accessed. Such computer readable instructions may be executed within a processor, such as central processing unit (CPU) 391, to cause computing system 300 to operate. In many workstations, servers, and personal computers, central processing unit 391 may be implemented by a single-chip CPU called a microprocessor. In other machines, the central processing unit 391 may comprise multiple processors. Coprocessor 381 may be an optional processor, distinct from main CPU 391, that performs additional functions or assists CPU 391.

In operation, CPU 391 fetches, decodes, and executes instructions, and transfers information to and from other resources via the computer's main data-transfer path, system bus 380. Such a system bus connects the components in computing system 300 and defines the medium for data exchange. System bus 380 typically includes data lines for sending data, address lines for sending addresses, and control lines for sending interrupts and for operating the system bus. An example of such a system bus 380 is the Peripheral Component Interconnect (PCI) bus. The computing system 300 may also include a loudspeaker/microphone 399 which may convert audio signals to sound and may output audio content. The loudspeaker/microphone 399 may also capture sound and may amplify the sound for output.

The computing system 300 may include an AI style component 398. The AI style component 398 may operate/function in a similar/analogous manner as the AI style component 247 of FIG. 2. The computing system 300 may present one or more AI style images, photos, pictures, or the like, generated by the AI style component 398, in one or more personalized user interfaces via the display 386. In some examples, the AI style component 398 may provide/present one or more generated AI style images, photos, pictures, or the like and the one or more personalized user interfaces to a UE(s) (e.g., UE(s) 230).

The memories of FIG. 3 may be coupled to system bus 380 and may include RAM 382 and ROM 393. Such memories may include circuitry that allows information to be stored and retrieved. ROM s 393 generally contain stored data that cannot easily be modified. Data stored in RAM 382 may be read or changed by CPU 391 or other hardware devices. Access to RAM 382 and/or ROM 393 may be controlled by memory controller 392. Memory controller 392 may provide an address translation function that translates virtual addresses into physical addresses as instructions are executed. Memory controller 392 may also provide a memory protection function that isolates processes within the system and isolates system processes from user processes. Thus, a program running in a first mode may access only memory mapped by its own process virtual address space; it cannot access memory within another process's virtual address space unless memory sharing between the processes has been set up.

In addition, computing system 300 may contain peripherals controller 383 responsible for communicating instructions from CPU 391 to peripherals, such as printer 394, keyboard 384, mouse 395, and disk drive 385.

Display 386, which is controlled by display controller 396, may be used to display visual output generated by computing system 300. Such visual output may include text, graphics, animated graphics, and video. The display 386 may also include or be associated with a user interface. The user interface may be capable of presenting one or more content items and/or capturing input of one or more user interactions associated with the user interface. Display 386 may be implemented with a cathode-ray tube (CRT)-based video display, a liquid-crystal display (LCD)-based flat-panel display, gas plasma-based flat-panel display, or a touch-panel. Display controller 396 includes electronic components required to generate a video signal that is sent to display 386.

Further, computing system 300 may contain communication circuitry, such as for example a network adaptor 397, that may be used to connect computing system 300 to an external communications network, such as network 212 of FIG. 2, to enable the computing system 300 to communicate with other nodes (e.g., UE 230) of the network.

### Exemplary System Operation

Some examples of the present disclosure may provide approaches and techniques to facilitate efficient and reliable mechanisms that facilitate the use of machine learning and/or AI to generate AI stylized photos, images, pictures, and/or the like of users associated with a platform, network, system, and/or the like. The photos, images, and/or the like may, but need not, be profile photos/pictures/images of one or more users associated with a platform, network, system, and/or the like. In other examples the photos, images, pictures, and/or the like may be any suitable photos, images, pictures, and/or the like of users associated with a platform, network, system, and/or the like. In some examples, the photos, images, pictures, and/or the like may be uploaded by users to a platform, network (e.g., network 140), system (e.g., system 100), and/or the like. In other examples, the images may be captured by a scan(s) of users (e.g., images of faces of users) detected by communication devices (e.g., by camera 254 of FIG. 2). In these examples, the scan(s) of the images may be performed and initiated by the users.

The exemplary aspects of the present disclosure may enable users to invoke and/or select a prompt (e.g., an input prompt), or click/select a button(s)/icon(s), capture of an audio instruction(s)/command(s), or the like to trigger generation of an AI image, photo, or picture (e.g., an AI profile picture) of a user(s) generated based on a current photo (e.g., current profile photo) of the user(s) and/or an uploaded image of the user(s), in a specific personalized/tailored manner and/or a style(s) desired by the user(s).

The new generated AI image/photo/picture (e.g., AI profile image) or the like may be provided to one or more other users of a platform, network (e.g., network 140), system (e.g., system 100), or the like to enable one or more of the other users to mimic (e.g., copy) the AI style of the new generated AI image/photo/picture to generate a new/updated AI image/photo/picture (e.g., a profile picture/image) associated with one or more of the other users.

The exemplary aspects of the present disclosure may utilize/implement AI to generate AI profile photos that may provide users AI photos that the users may desire to personalize/stylize their profile images and/or other images associated with a platform, network, system, or the like. For purposes of illustration and not of limitation, as an example, the exemplary aspects may provide/generate AI styles to images (e.g., profile images) to generate AI based three-dimensional (3D) cartoon characters, AI based professional looking headshots, AI based artistic renderings of images, and/or the like. In this manner, the exemplary aspects may enable users to express themselves in an authentic manner. In some instances, the users of a platform/network/system may use generated AI styled images to make their user profile images feel fun, fresh, and playful. The generated AI styled images when provided to other users and/or interacted with by other users may inspire or entice the other users to update one or more of their associated images (e.g., profile images) in a similar manner (e.g., by mimicking the AI style image of another user). As such, the exemplary aspects may enable creation of AI generated images having AI styles that may go viral (e.g., increased or fast/widespread sharing and interaction/engagement of AI generated images which may result in surges among and increased popularity among users) associated with a platform, network, system, or the like.

In some instances, the exemplary aspects of the present disclosure may generate/provide a library of suggested AI art styles that may be utilized (e.g., chosen) by users to apply to one or more images. In this manner, the exemplary aspects may allow users to express themselves in an authentic manner by providing the users the ability to fine tune their photos, images, or the like in the manner the users desire.

In some examples, the present disclosure is generally directed to a framework for generative stylized profile pictures, generated for users of a social media platform (e.g., system 100). In some examples, a generative stylized profile picture may represent an image that results when a text-based prompt is applied to an input image (e.g., an existing profile image and/or an image captured and/or uploaded by a user) via a generative system (e.g., AI style component 247, AI style component 398) (e.g., a generative artificial intelligence model, a computer vision algorithm, etc.). The input image may be stylized using a variety of techniques including, without limitation, style transfer (e.g., applying a designated artistic style to the input image, image transformation (e.g., applying a transformation to the input image such as a rotation, flipping, cropping, etc.), and/or content manipulation (e.g., adding or removing objects, changing a background, altering an appearance of an object, etc.).

The disclosed framework (e.g., AI style component 247, AI style component 398) may enable users to create generative stylized profile pictures from a variety of entry points. In some examples, a user may be presented (e.g., by the display/touchpad/user interface 242 and/or display 386) with a stylized profile picture of another user (e.g., via a social media feed and/or stream) and the stylized profile picture may serve as an entry point that enables the user to generate a generative stylized profile picture that matches a style of the other user's stylized profile picture. In these examples, the framework (e.g., AI style component 247, AI style component 398) may generate the matching stylized profile picture for the user in a variety of ways. In one example, a prompt that formed the basis of the other user's stylized profile picture (e.g., a prompt used to generate the other user's stylized profile picture) may be saved in a database (e.g., data store 164, non-removable memory 244, removable memory 246, RAM 382, ROM 393) in association with the other user's stylized profile picture. In this example, the framework may generate the matching stylized profile picture for the user by applying the prompt, used to generate the other user's stylized profile picture, to the user's current profile picture (e.g., and/or any other picture selected and/or uploaded by the user).

In some examples, a user may be presented (e.g., by the display/touchpad/user interface 242 and/or display 386) with a digital digest of themes (e.g., styles) that may be used to create generative stylized profile pictures (e.g., a digest of platform-generated themes). In these examples, the user may select a theme from the digest to have modifications corresponding to the theme applied to an input image (e.g., the user's current profile picture and/or another picture selected and/or uploaded by the user). In one such example, each theme may be associated with a prompt and the framework (e.g., AI style component 247, AI style component 398) may generate a generative stylized profile picture with a selected theme by applying a prompt associated with the selected theme to the input image provided by the user.

In some examples, the framework may provide the user with an interface or interface element (e.g., a user interface(s)) that enables the user to create a new prompt to apply to an input picture of the user. In these examples, the framework (e.g., AI style component 247, AI style component 398) may apply a new prompt provided by a user to an input image provided by the user and the resulting stylized picture may be used as a profile picture for the user. In some examples (as dictated by a privacy setting), the prompt may be saved in a database (e.g., data store 164, non-removable memory 244, removable memory 246, RAM 382, ROM 393) in association with the user's profile picture (e.g., such that other users may create matching profile pictures as described previously).

In certain examples, the framework may enable users of the social media platform (e.g., system 100) to build onto a creative process initiated by other users and/or by the social media platform. For example, a user may select a stylized picture (e.g., posted as another user's profile picture) and/or theme (e.g., presented in a digest of themes) and provide a text-based prompt to modify the style of the selected stylized picture and/or theme in some way.

While this description may focus on example embodiments in which a stylized picture is used as a profile picture, a stylized picture generated using the processes described herein may be used in a variety of ways (e.g., for downloading, sharing, posting, etc.).

In some example embodiments, the various methods and systems described herein may be performed wholly or in part by a hardware processor executing software instructions stored in a memory. Such operations may be performed within a server or other cloud-accessible device, a desktop or laptop computer, a tablet computer, a smartphone, etc.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

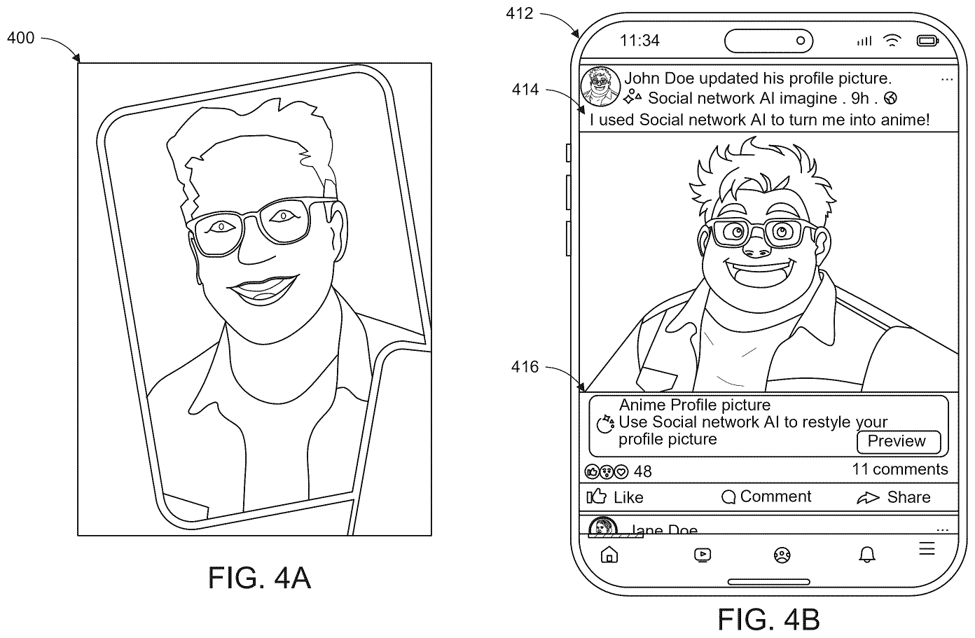

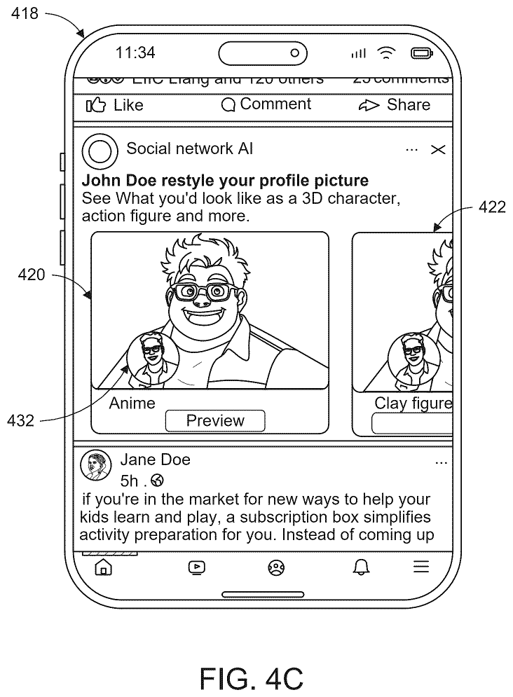

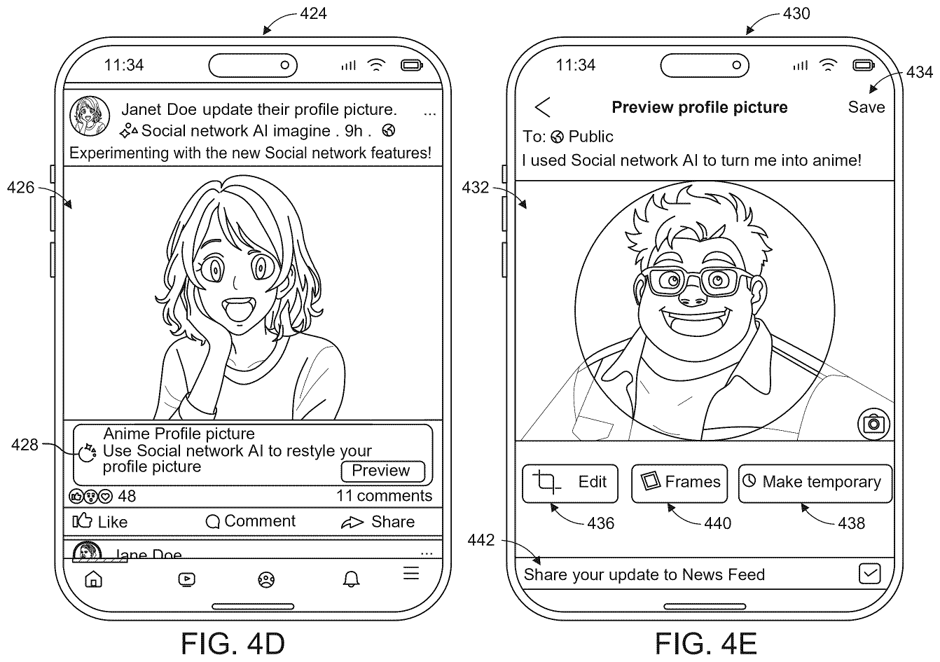

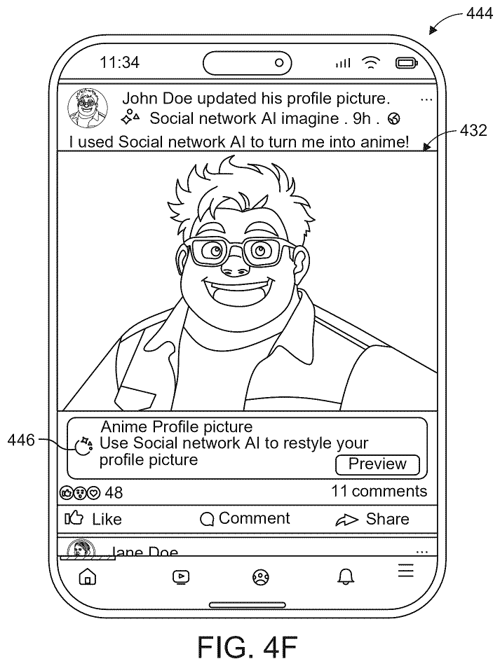

Referring to FIG. 4A and FIG. 4B, an example of generating an AI stylized image associated with a user is provided in accordance with an example aspect of the present disclosure. FIG. 4A illustrates a diagram of a profile picture 400 of a user, associated with a platform, network (e.g., network 140), system (e.g., system 100), or the like. In the example of FIG. 4A, the user may be a fictitious user (e.g., a fictitious user named John Doe). In the example of FIG. 4A and FIG. 4B, an AI style component (e.g., AI style component 247, AI style component 398) may detect an input(s) (e.g., input of a prompt, input text, capture of an audio command(s), etc.), a selection (e.g., selection of a button, icon, etc.), or the like associated with a user interface (e.g., user interface 412) providing an indication that the user, associated with the profile picture 400, desires to provide an AI style(s) to the profile picture 400.

In some examples, the input(s) may be detected based on receipt of content from a device (e.g., the display/touchpad/user interface 242, the display 386). In some other examples, the input(s) may, but need not, for example be an audio input(s) captured by an audio component (e.g., speaker/microphone 238, loudspeaker/microphone 399) of a communication device (e.g., UE 230, computing system 300). The audio input(s) may be speech data (e.g., voice data) of the user speaking a command(s)/instruction(s) that may be captured by the audio component and provided to the AI style component to enable the AI style component to generate an AI image/photo/picture based on the command (e.g., Use AI to turn profile picture into anime). In the example of FIG. 4B, the user may select a prompt 414, which may trigger the AI style component to turn the profile picture (e.g., profile picture 400) into an anime picture/image (e.g., an anime profile picture 416) associated with the user of the profile picture. In this regard, the user may utilize AI (e.g., AI style component 247, AI style component 398) to restyle the user's profile picture 400 to an AI anime picture/image (e.g., an anime profile picture 416). In the example of FIG. 4B, the user interface 412 may indicate that the user (e.g., John Doe) updated the profile picture.

The AI style component (e.g., AI style component 247, AI style component 398) may enable users to quickly mimic (e.g., copy) a generated AI styled image and apply such AI styled image to a profile photo of the corresponding user(s). The AI style component may utilize a number of approaches to generate an AI style image(s). For example, the AI style component may implement a direct mimicry technique such that in an instance in which one or more other users view a profile photo of another/first user's created/generated profile photo using an AI style, the one or more other users may utilize the AI style component to create a version of the first user's profile photo using the same AI style to achieve a similar AI look/style associated with the first user's profile photo. For instance, a first user may utilize either a custom AI prompt to generate an image (e.g., an AI image), or select an AI style from a predetermined list (e.g., the predetermined styles of the list may have prompts associated with the predetermined styles, which in some instances may not be seen by a user). The first user may then apply the AI style to their photo/profile picture. For example, in an instance in which a second user views an AI stylized photo from the first user, the second user may be able to directly mimic the AI style used by clicking a “try it” button, icon, or the like. The AI style may then be applied to a photo of the second user. In some examples, the AI style may be applied to the photo of the second user based on storing the prompt (e.g., the AI prompt) associated with the image/photo of the first user as metadata and using the metadata, which may be stored at a network device (e.g., computing system 300) to allow the second user to use the same prompt to generate the AI style photo without the need to view the prompt.

In some other examples, the AI style component (e.g., AI style component 247, AI style component 398) may detect one or more pre-generated (e.g., predetermined) options to facilitate applying of an AI style to a profile picture(s) (e.g., e.g., profile picture 432) of one or more users. For example, instead of mimicking another user's AI style directly, a user(s) may choose from a list of pre-generated AI styles in a user interface (e.g., user interface 418) to apply to a profile photo of the user(s). In some examples, the one or more users may be fictitious users such as, for example, John Doe, Jane Doe, James Doe, etc.

For instance, in the example of FIG. 4C, a user (e.g., John Doe) may choose from a pre-generated list of AI styles, in a user interface (e.g., user interface 418), such as for example an anime AI style option 420 and a clay figure AI style option 422. There may also be other AI style options from which a user may choose from in the pre-generated/predetermined list of AI styles. Some examples of other AI style options from which a user may choose may include, but are not limited to, a dollhouse AI style (e.g., similar to a toy doll), a clay figure anime AI style (e.g., similar to Japanese animation, (e.g., sitar to a hand crafted felt doll)), a cartoon AI style, a comic AI style, a 3D character style (e.g., similar to 3D animation), a kawaii caricature AI style (e.g., based on a Japanese cultural concept), and other AI art styles.

As shown in FIG. 4C, a preview of an anime AI style option 420 of a profile picture (e.g., profile picture 432) is shown in the user interface 418 and a preview of a clay figure AI style option 422 of the profile picture is shown in the user interface 418. As an example, the anime AI style option 422 may apply an AI style to an image (e.g., profile picture 432) such as, for example, an anime figure, character, or the like.

In some other examples, the anime profile picture 416 may be generated by the AI style component (e.g., AI style component 247, AI style component 398) based on applying the direct mimicry approach/technique. For example, in an instance in which the user (e.g., John Doe) is presented a view of an anime AI style of another profile picture (e.g., of another fictitious user Jane Doe), the user (e.g., John Doe) may make a selection in a user interface showing the user's profile picture (e.g., profile picture 432, profile picture 400) to mimic the anime AI style and thus apply the same anime AI style to the user's profile picture (e.g., the profile picture 432, profile picture 400). In this regard, in response to detection of the indication of the selection, the AI style component may apply the anime AI style (e.g., anime profile picture 420) to the profile picture of the user (e.g., John Doe).

Referring now to FIG. 4D, FIG. 4E and FIG. 4F, diagrams illustrating an exemplary direct mimicry flow process are provided in accordance with examples of the present disclosure. In the example FIG. 4D, a communication device (e.g., UE 230, computing system 300) of a first user (e.g., John Doe) may receive and/or be presented with a user interface 424 indicating a representation (e.g., a visual representation) of a user contact, i.e., a second user (e.g., a fictitious user named Janet Doe) associated with the first user, which has updated their profile picture by using AI features (e.g., AI style component 247, AI style component 398). In the example of FIG. 4D, the second user (e.g., Janet Doe) made a selection to utilize AI features (e.g., AI style component 247, AI style component 398) to update their profile picture to a new anime AI style profile picture 426.

The first user (e.g., John Doe) being presented the user interface 424 may view the second user's (e.g., Janet Doe) anime AI style profile picture 426 and the first user may perform a selection (e.g., a tap, etc.) from a prompt 428 to utilize AI features (e.g., AI style component 247, AI style component 398) to restyle the first user's profile picture (e.g., profile picture 400) in a similar AI style as the second user's anime AI style profile picture 426. In this regard, the selection of the prompt 428 may be to mimic (e.g., copy) the AI style of the anime AI style profile picture 426 of the second user (e.g., Janet Doe) to the picture profile (e.g., picture profile 400) of the first user.

In response to detecting/capturing the indication of the selection of the prompt 428, the AI style component (e.g., AI style component 247, AI style component 398) may mimic the AI style of the anime AI style profile picture 426 and apply a similar/the same AI style to the profile picture (e.g., profile picture 400) of the first user. In this manner, the AI style component may present the communication device (e.g., UE 230, computing system 300) of the first user a user interface 430, as shown in FIG. 4E, indicating a representation (e.g., visual representation) of a preview of an updated or new anime AI style profile picture 432 that may be mimicked from the AI style of the anime AI style profile picture 426 of the second user. The first user may review the preview of the new anime AI style profile picture 432 presented in the user interface 430 and if the first user likes new anime AI style profile picture 432, the first user may save the new anime AI style profile picture 432 (e.g., by clicking save tab 434).

On the other hand, in an instance in which the first user desires changes/updates to the new anime AI style profile picture 432, the first user may select the Edit tab 436 to make changes (e.g., to change/update to another/different AI style/AI theme, (e.g., a clay figure AI style), etc.). For instance, selection of the Edit tab 436 may invoke presentation of a prompt screen to customize the AI style profile picture 432. Additionally, the first user may make the new anime AI style profile picture 432 temporary by selecting the make temporary tab 438.

Additionally, the first user may select the prompt 442 to share the new anime AI style profile picture 432 in a feed (e.g., a news feed). In this regard, in response to detection of the selection of the prompt 442, the AI style component may share the feed (e.g., news feed) of the new anime AI style profile picture 432 with one or more other users (e.g., other contacts of the first user) associated with a platform, network (e.g., network 140) and/or system (e.g., system 100).

By sharing or providing the news feed of the new anime AI style profile picture 432 to one or more other users, the AI style component may enable the other users to mimic the AI style of the new anime AI style profile picture 432 to apply the AI style of the new anime AI style profile picture to the profile pictures of the other users in a similar manner as described above. For example, as shown in FIG. 4F in an instance in which the first user chose/selected to save (e.g., via the save tab 434) the new anime AI style profile picture 432, the AI style component may generate the user interface 444 indicating the new anime AI style profile picture 432 and the user interface 444 may indicate a prompt 446 in which other users may select, when being presented the new anime AI style profile picture 432 (e.g., via the news feed). In response to selecting the prompt 446, the AI style component may apply (e.g., mimic or copy) the AI style of the new anime AI style profile picture 432 to one or more profile pictures of the other users.

In the example of FIG. 4F, the AI style component may also indicate in the user interface 444 that the first user utilized AI to update the first user's prior profile picture (e.g., profile picture 400) to the anime and that the first user's profile picture is updated.

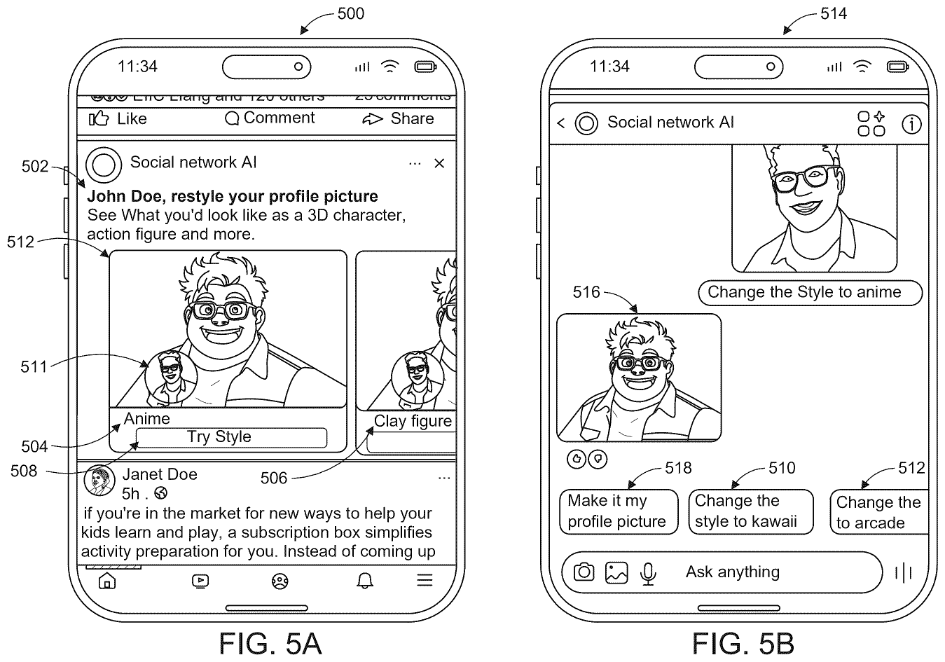

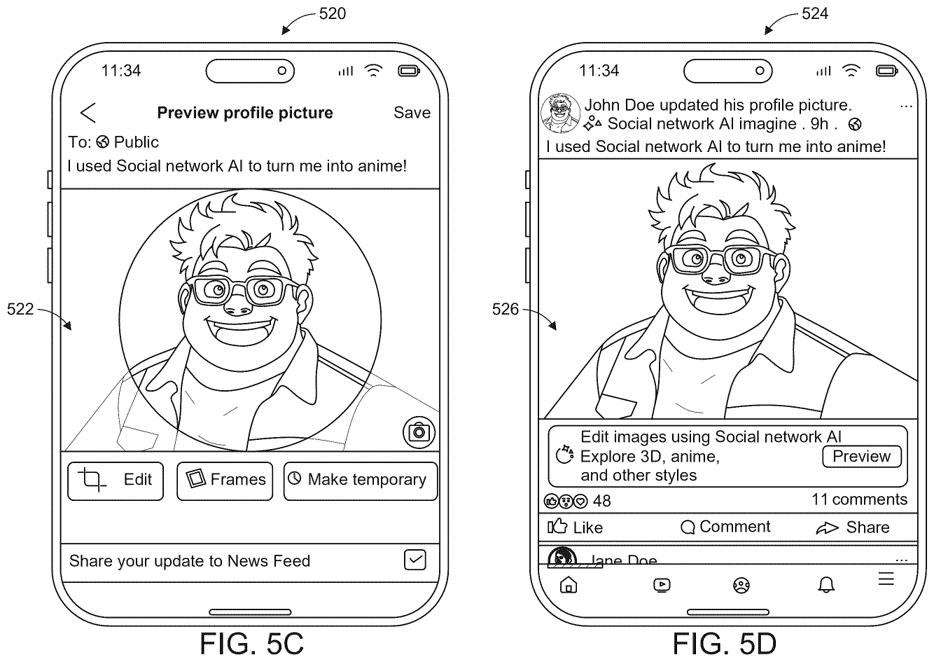

Referring now to FIG. 5A, FIG. 5B, FIG. 5C and FIG. 5D, diagrams illustrating an exemplary pre-generated options flow process to generate AI style images are provided in accordance with examples of the present disclosure. As indicated in FIG. 5A, the AI style component (e.g., AI style component 247, AI style component 398) may provide/present a user interface 500 to a first user (e.g., John Doe). In the example of FIG. 5A, the user interface 500 may include content (e.g., visual content) indicating an option such as a prompt 502 to restyle a profile picture (e.g., profile picture 400). In this regard, the AI style component may present the user interface 500 with one or more (e.g., a list) of pre-generated and/or predetermined AI styles as options to apply to a profile picture.

In the examples of FIGS. 5A and 5B, the list of pre-generated AI styles may be an anime AI style option 504, a clay figure AI style option 506, as well as other AI style options (e.g., a kawaii AI style option 510, an arcade AI style option 512, etc.).

For purposes of illustration and not of limitation, in response to detection/capture of a selection of a try style tab 508, the AI style component may generate a preview of an anime AI style profile picture 512 which may include a smaller or reduced image (e.g., a thumbnail image 511) of the current profile picture (e.g., profile picture 400) of the first user. In this regard, the first user may review the preview to determine whether the first user may desire to utilize the anime AI style profile picture 512 as the first user's profile picture.

In this regard, as shown in FIG. 5B, in an instance in which the first user may desire to utilize the anime AI style profile picture 512 as the first user's profile picture, the first user may initiate communication (e.g., a short message service (SM S) message (e.g., text message, multimedia message, etc.)) in a user interface 514 with an AI bot (e.g., AI chatbot) to change or update the first user's current profile picture (e.g., profile picture 400) to a style such as anime. In some examples, the AI style component (e.g., AI style component 247, AI style component 398) may be the AI bot.

The AI bot may present an anime AI style profile picture 516 to the first user in the user interface 514 in another communication (e.g., an SMS message). In some examples, the anime AI style profile picture 516 may be similar to the anime AI style profile picture 512, with the exclusion of the thumbnail image 511. Within the user interface 514, the first user may select a like prompt (e.g., a thumbs up icon) to like the anime AI style profile picture 516 and/or may select a dislike prompt (e.g., a thumbs down icon) to dislike the anime AI style profile picture 516. The first user may select a prompt 518 to make the anime AI style profile picture 516 the user's current profile picture. On the other hand, in an instance in which the first user desires not to apply the anime AI style profile picture 516 as the first user's profile picture, the first user may select a kawaii AI style option 510, an arcade AI style option 512, or another AI style option(s) (e.g., a clay figure AI style) in which to change/update the picture profile (e.g., profile picture 400) of the first user.

In the example of FIG. 5C, in response to detection of a selection of the prompt 518 to make the anime AI style profile picture 516 the user's current picture profile, the AI style component may generate the user interface 520 including content (e.g., visual content) indicating a preview of an anime AI style profile picture 522. The anime AI style profile picture 522 may be analogous to the AI style profile picture 516.

In the example of FIG. 5D, the AI style component may generate the user interface 524 indicating an anime AI style profile picture 526 (e.g., analogous to anime AI style profile picture 522). In an instance in which the user interface 524 may be provided by the AI style component (e.g., via a shared news feed, or other communication (e.g., a message)) to one or more other users of a platform, network, system (e.g., system 100), the other users may mimic (e.g., copy) the AI style of the anime AI style profile picture 526 to apply the AI style to one or more profile pictures of the other users, in the manner described above.

It should be pointed out that the above examples of FIGS. 4A, 4B, 4C, 4D, 4E, 4F and FIGS. 5A, 5B, 5C, and 5D associated with applying AI styles to profile pictures is for purposes of illustration and not of limitation and that such applying of AI styles may be applied to any suitable images, pictures, photos, or the like associated with one or more users (e.g., users of a platform, network, system, etc.).

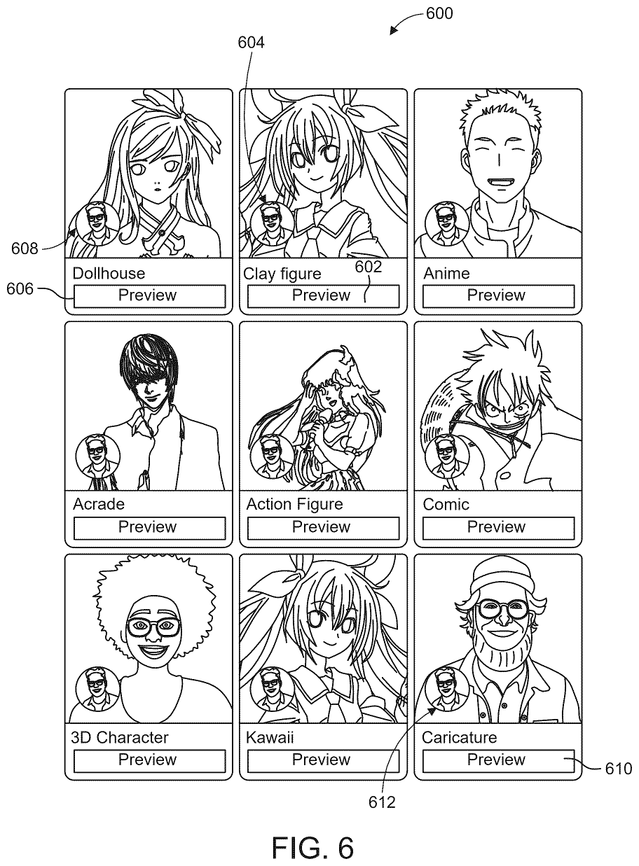

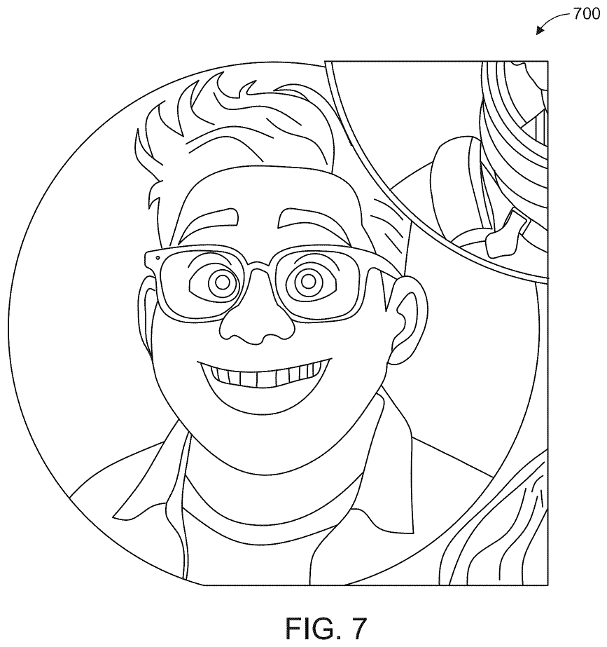

Referring now to FIG. 6, a diagram illustrating a plurality of AI styles to generate personalized AI stylized images are provided in accordance with an example of the present disclosure. In some examples, the plurality of AI styles may be part of a library 600 (e.g., an AI style library) of AI options to stylize images. In this regard, the library 600, may enable the AI style component (e.g., AI style component 247, AI style component 398) to provide the ability to users to express themselves in an authentic manner by enabling users to fine tune their images, photos, pictures, or the like in the manner the users desire. In FIG. 6, in some examples the plurality of AI styles may include, but are not limited to, a dollhouse art style (e.g., a doll art style), a clay figure art style, an anime art style, an arcade art style, an action figure art style, a comic art style, a 3D character art style, a kawaii art style, a caricature art style and other suitable art styles (e.g., avatars, pop art theme art style, oil painting theme art style, etc.).

In the example of FIG. 6, a user(s) may choose to fine tune one or more images of the user(s) associated with a network by selecting a preview (e.g., a preview tab, preview button, or the like) of one or more of the art styles of the library 600 and in response to detection of the selection of the preview (e.g., the preview tab, preview button, or the like) corresponding to a particular AI art style(s), the AI style component (e.g., AI style component 247, AI style component 398) may generate an AI art style of an image(s) (e.g., profile picture 400) of the user(s) in the AI art style.

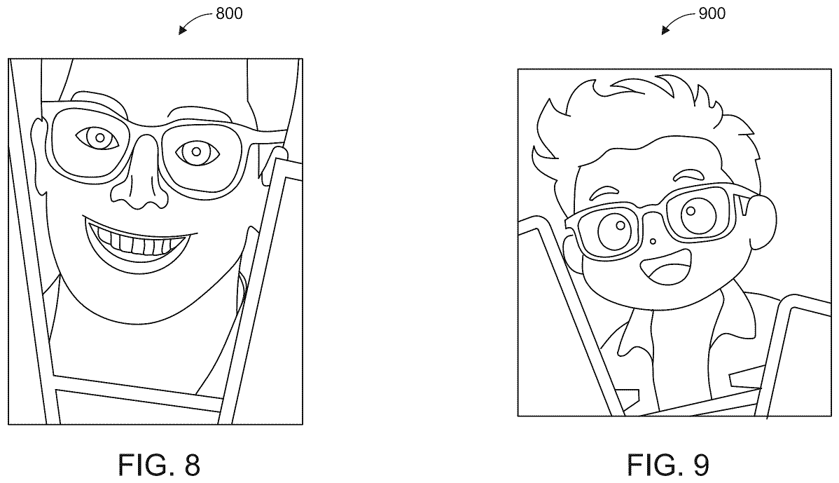

For purposes of illustration, and not of limitation, for example, a user (e.g., e.g., John Doe) may select the preview tab 602 associated with a clay figure AI style and in response to the detection of the selection, the AI style component may generate a clay FIG. 700 associated with an image (e.g., a profile picture 604) of the user, as shown in FIG. 7. As another example, the user (e.g., e.g., John Doe) may select the preview tab 606 associated with a dollhouse or doll AI style and in response to the detection of the selection by the AI style component, the AI style component may generate a doll like image 800 associated with an image (e.g., a profile picture 608) of the user, as shown in FIG. 8.

In another example, the user (e.g., John Doe) may select the preview tab 610 associated with a caricature AI style and in response to the detection of the selection by the AI style component, the AI style component may generate a caricature image 900 associated with an image (e.g., a profile picture 612) of the user, as shown in FIG. 9.

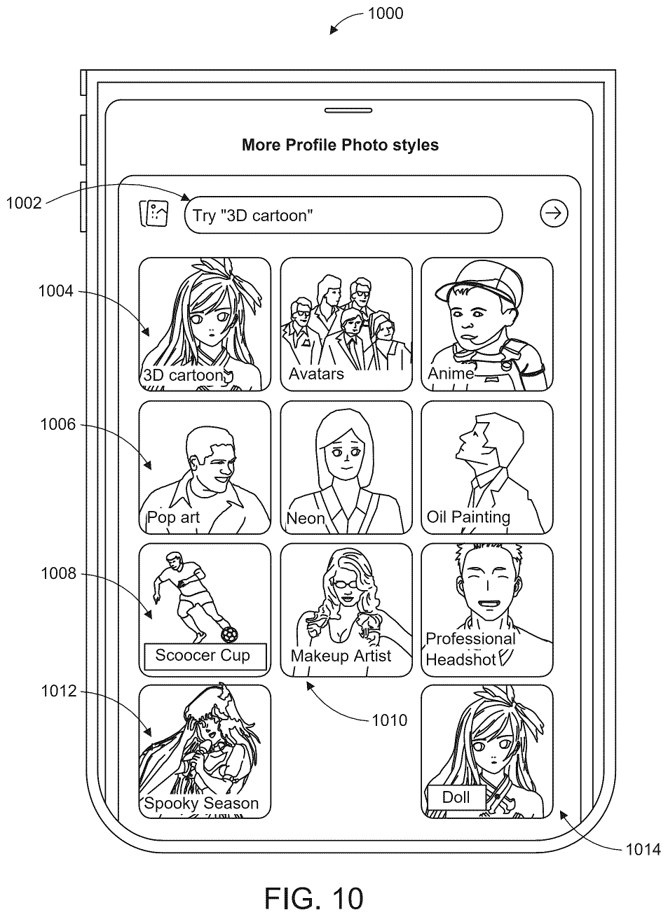

Referring now to FIG. 10, a diagram illustrating a manner in which to enter or input prompts within a user interface to generate one or more AI photo styles is provided in accordance with an example of the present disclosure. For purposes of illustration and not of limitation, for example, in response to detection of an input(s) 1002 (e.g., an input prompt) such as, for example, 3D cartoon or “Try 3d cartoon” in the user interface 1000, the AI style component may apply a 3d cartoon 1004 AI style to a profile picture (e.g., profile picture 400) to generate a new and/or updated profile picture associated with the 3D cartoon AI style. In a similar manner, the AI style component may detect other inputs (e.g., input prompts) within, or associated with, the user interface 1000 and may generate other updated picture profiles in other AI styles (e.g., avatars, anime, pop art 1006, neon, oil painting, soccer cup 1008, makeup artist 1010, professional headshot, spooky season 1012, doll 1014, etc.).

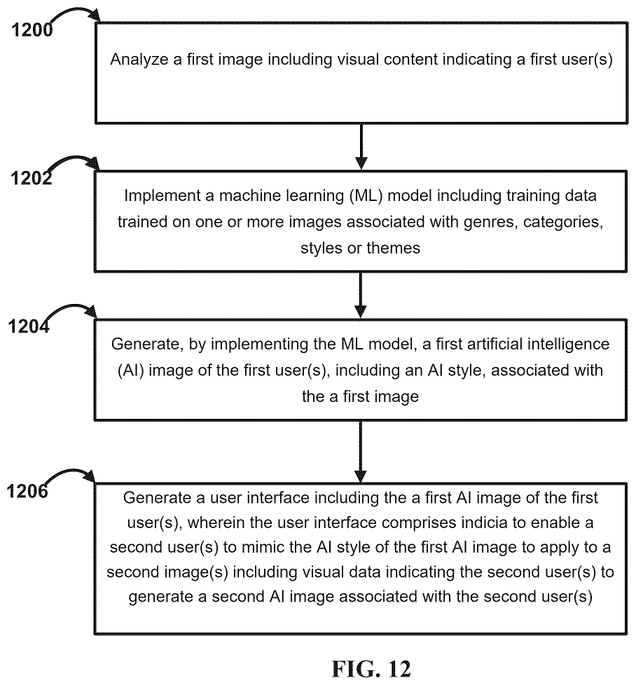

FIG. 11 illustrates an example of a machine learning framework 1100 including machine learning model(s) 1130 and a training database 1150 in accordance with one or more examples of the present disclosure. The training database 1150 may store training data 1120. In some examples, the machine learning framework 1100 may be hosted locally in a computing device or hosted remotely. By utilizing the training data 1120 of the training database 1150, the machine learning framework 1100 may train the machine learning model(s) 1130 to perform one or more functions, described herein, of the machine learning model(s) 1130. In some examples, the machine learning model(s) 1130 may be stored in a computing device. For example, the machine learning model(s) 1130 may be embodied within a communication device (e.g., UE 230). In some other examples, the machine learning model(s) 1130 may be embodied within another device (e.g., computing system 300). Additionally, the machine learning model(s) 1130 may be processed by one or more processors (e.g., processor 232 of FIG. 2, co-processor 381 of FIG. 3). In some examples, the machine learning model(s) 1130 may be associated with operations (or performing operations) of FIG. 12. In some other examples, the machine learning model(s) 1130 may be associated with other operations.

In an example, the training data 1120 may include attributes of thousands of objects. For example, the objects may be specifications (e.g., technical specifications) of communication devices, settings of communication devices, posters, brochures, billboards, menus, goods (e.g., packaged goods), books, groceries, Quick Response (QR) codes, smart home devices, home and outdoor items, household objects (e.g., furniture, kitchen appliances, etc.) and any other suitable objects. In some other examples, the objects may be smart devices (e.g., UEs 230, communication devices 105, 110, 115, 120), persons (e.g., users), newspapers, articles, flyers, pamphlets, signs, cars, content items (e.g., messages, notifications, images, videos, audio), and/or the like. Attributes may include, but are not limited to, the size, shape, orientation, position/location of the object(s), etc. The training data 1120 employed by the machine learning model(s) 1130 may be fixed or updated periodically. Alternatively, the training data 1120 may be updated in real-time based upon the evaluations performed by the machine learning model(s) 1130 in a non-training mode. This may be illustrated by the double-sided arrow connecting the machine learning model(s) 1130 and the stored training data 1120. In some examples, the machine learning model(s) 1130 may be, or may be implemented by, the AI style component 247 and/or the AI style component 398.

Some other examples of the training data 1120 may include, but are not limited to, items of content determined as being associated with one or more images, and/or videos, and one or more content items associated with one or more genres, types, categories, styles, themes, patterns, features that may be applicable to images (e.g., profile pictures, other images, images of faces, etc.) of one or more users. Additionally or alternatively, training data 1120 may include, but is not limited to, user behaviors associated with preferences related to types of content (e.g., avatars (e.g., 3D avatars associated with tailored/personalized attributes), other digital representations chosen by users) that users may choose to interact with/engage with across various demographics (e.g., age, occupation, gender, marital status, etc.). The training data 1120 of the training database 1150 may be utilized, in part, to pre-train, and/or train in real-time, the machine learning model(s) 1130.

By utilizing the example aspects of the present disclosure providing artificial intelligence and/or machine learning approaches to automatically personalize/tailor images (e.g., profile images, images of faces, etc.) of users in various AI styles/AI themes within or associated with user interfaces of a communication device, may enable provision of more robust, efficient and user-friendly user interfaces, which may enhance user interactions/engagements with communication devices and/or applications to generate the various user image AI styles/AI themes, in real time, that cater to the desires of users (e.g., in the manner that the users desire to represent themselves). This may be unlike conventional/existing approaches that may require a user to manually upload (e.g., to a platform/network) photos of themselves to create an altered photo that accurately represents themselves for representation via user interfaces, which may be burdensome and cumbersome and which may decrease user interface interaction/engagement as users may be disinterested with such cumbersome processes to alter a representation of themselves across a platform, network, system, or the like.

The example aspects of the present disclosure may provide technical improvements in the field of user interface technology by enhancing a user experience and enhancing user interaction with content by enabling users to generate, in real time, and interact with dynamically tailored user specific images having AI styles (e.g., AI images) within, or associated with, user interfaces (e.g., user specific/personalized user interfaces).

Additionally, by the exemplary aspects of the present disclosure enabling users associated with a platform, network, system, or the like to efficiently mimic an AI style of an image of another user being presented within a user interface such that the same AI style(s) may be applied to an image(s) of a requesting/desiring user, the exemplary aspects may provide technical improvements to communication devices by conserving processing capacity of the communication devices. For example, the brute force manual approaches of altering images depicting users may be processor intensive on communication devices, which may undesirable consume (e.g., overload) processor device resources of communication devices. Such manual brute force approaches of existing systems are negated and alleviated by the exemplary aspects as described above, and thus the exemplary aspects of the present disclosure may conserve (e.g., reduce) processing resources of communication devices (which may minimize processing device overload).

Additionally, by enabling users of a platform, network, system, or the like (which may have millions of associated users) to mimic image AI styles within user interfaces by choosing user friendly selections, such minimizes/conserves network traffic across a network (e.g., network 140). For example, the network traffic may be conserved by minimizing network devices responding to requests (e.g., by several (e.g., millions) users) and generating altered image content to communicate across the network, thus conserving network bandwidth.

Additionally, the exemplary aspects of the present disclosure may provide safety features (e.g., privacy (e.g., data privacy (e.g., providing anonymization features, preserving confidential information associated with biometric content of users))) for users that may not want to show/reveal their real face(s) by enabling the users to utilize their generated AI image having an AI style (for example in a profile picture). The exemplary aspects of the present disclosure may conserve/save resources (e.g., computing resources) and time, as well as speed, since a user may not have to create an image (e.g., an AI image) themselves. For instance, the exemplary aspects of the present disclosure may provide automated approaches to create/generate AI images associated with users. The exemplary aspects of the present disclosure may also provide memory device storage conservation since the AI images may be generated by a network (e.g., computing system 300) and may not need to be saved locally on a client device (e.g., a user device (e.g., UE 230)).

FIG. 12 illustrates an example flowchart illustrating operations to generate one or more AI images having AI styles according to an example of the present disclosure. At operation 1200, a device (e.g., AI style component 247, AI style component 398) may analyze a first image(s) (e.g., profile picture 400) including visual content indicating a first user(s). For purposes of illustration and not of limitation, for example, the first user(s) may a fictitious user (e.g., John Doe), and may be associated with a platform, network (e.g., network 140), system (e.g., system 100), or the like.

At operation 1202, a device (e.g., AI style component 247, AI style component 398) may implement a machine learning model (e.g., machine learning model(s) 1130) including training data (e.g., pre-trained, or trained in real-time) trained on one or more images associated with genres, categories, styles or themes. In some examples, the one or more images may include, but are not limited to, still images, videos, and/or other content items.

At operation 1204, a device (e.g., AI style component 247, AI style component 398) may generate, by implementing the machine learning model, a first artificial intelligence image (e.g., anime profile picture 416) of the first user(s), including an AI style (e.g., anime AI style, clay figure AI style, arcade AI style, etc.), associated with the first image (e.g., profile picture 400).

At operation 1206, a device (e.g., AI style component 247, AI style component 398) may generate a first user interface (e.g., user interface 412, user interface 424, etc.) including the first AI image (e.g., anime profile picture 416, anime AI style profile picture 426) of the first user(s). The first user interface may include indicia to enable a second user(s) (e.g., a fictitious person such as John Doe, James Doe, Jane Doe, etc.) to mimic the AI style the first AI image (e.g., anime profile picture 416, anime AI style profile picture 426) to apply to a second image (e.g., a second profile picture (e.g., profile picture 432)), including visual data indicating the second user(s), to generate a second AI image (e.g., anime AI style profile picture 432) associated with the second user(s).

### Alternative Embodiments

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of applications and symbolic representations of operations on information. These application descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as components, without loss of generality. The described operations and their associated components may be embodied in software, firmware, hardware, or any combinations thereof.

Any of the steps, operations, or processes described herein may be performed or implemented with one or more hardware or software components, alone or in combination with other devices. In one embodiment, a software component is implemented with a computer program product comprising a computer-readable medium containing computer program code, which can be executed by a computer processor for performing any or all of the steps, operations, or processes described.

Embodiments also may relate to an apparatus for performing the operations herein. This apparatus may be specially constructed for the required purposes, and/or it may comprise a computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments also may relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed:

1. A method comprising:
analyzing a first image comprising visual content indicating a first user;
implementing a machine learning (ML) model comprising training data trained on one or more images associated with genres, categories, styles or themes;
generating, by implementing the ML model, a first artificial intelligence (AI) image of the first user, comprising an AI style, associated with the first image; and
generating a first user interface comprising the AI image of the first user, wherein the first user interface comprises indicia to enable a second user to mimic the AI style of the first AI image to apply to a second image comprising visual data indicating the second user to generate a second AI image associated with the second user.

2. The method of claim 1, wherein the first image comprises a profile picture of the first user and the method further comprises updating the profile picture to the first AI image.

3. The method of claim 1, further comprising:
generating a second user interface presenting the second AI image of the second user comprising the AI style associated with the first AI image in response to detection of a selection to mimic the AI style of the first AI image.

4. The method of claim 1, wherein:
the generating the first user interface comprising the first AI image comprises generating the first user interface in response to detection of a selection of a predetermined option from a plurality of predetermined options associated with a plurality of different AI styles.

5. The method of claim 1, wherein the first image of the first user comprises a first profile picture of the first user and the second image comprises a second profile picture associated with the second user.

6. The method of claim 1, further comprising:
updating the first user interface to indicate a third AI image comprising a different AI style associated with the first user in response to detection of an indication to change the first AI image.

7. The method of claim 3, wherein:
the generating the second user interface presenting the second AI image of the second user is in response to receipt by the second user of the first user interface comprising the first AI image of the first user.

8. The method of claim 7, wherein:
the receipt by the second user is via a feed comprising the first user interface comprising the first AI image.

9. The method of claim 4, wherein:
the plurality of different AI styles comprises one or more of anime, clay figure, doll, arcade, action figure, comic, three-dimensional (3D) character, kawaii or caricature AI styles.

10. An apparatus comprising:
one or more processors; and at least one memory storing instructions, that when executed by the one or more processors, cause the apparatus to:
analyze a first image comprising visual content indicating a first user;
implement a machine learning (ML) model comprising training data trained on one or more images associated with genres, categories, styles or themes;
generate, by implementing the ML model, a first artificial intelligence (AI) image of the first user, comprising an AI style, associated with the first image; and
generate a first user interface comprising the AI image of the first user, wherein the first user interface comprises indicia to enable a second user to mimic the AI style of the first AI image to apply to a second image comprising visual data indicating the second user to generate a second AI image associated with the second user.

11. The apparatus of claim 10, wherein the first image comprises a profile picture of the first user and the wherein when the one or more processors further execute the instructions, the apparatus is configured to:
update the profile picture to the first AI image.

12. The apparatus of claim 10, wherein when the one or more processors further execute the instructions, the apparatus is configured to:
generate a second user interface presenting the second AI image of the second user comprising the AI style associated with the first AI image in response to detection of a selection to mimic the AI style of the first AI image.

13. The apparatus of claim 10, wherein when the one or more processors further execute the instructions, the apparatus is configured to:
perform the generate the first user interface comprising the first AI image by generating the first user interface in response to detection of a selection of a predetermined option from a plurality of predetermined options associated with a plurality of different AI styles.

14. The apparatus of claim 10, wherein the first image of the first user comprises a first profile picture of the first user and the second image comprises a second profile picture associated with the second user.

15. The apparatus of claim 10, wherein when the one or more processors further execute the instructions, the apparatus is configured to:
update the first user interface to indicate a third AI image comprising a different AI style associated with the first user in response to detection of an indication to change the first AI image.

16. The method of claim 12, wherein when the one or more processors further execute the instructions, the apparatus is configured to:
perform the generate the second user interface presenting the second AI image of the second user in response to receipt by the second user of the first user interface comprising the first AI image of the first user.

17. The apparatus of claim 16, wherein:
the receipt by the second user is via a feed comprising the first user interface comprising the first AI image.

18. The apparatus of claim 13, wherein:
the plurality of different AI styles comprises one or more of anime, clay figure, doll, arcade, action figure, comic, three-dimensional (3D) character, kawaii or caricature AI styles.

19. A non-transitory computer-readable medium storing instructions that, when executed, cause:
analyzing a first image comprising visual content indicating a first user;
implementing a machine learning (ML) model comprising training data trained on one or more images associated with genres, categories, styles or themes;
generating, by implementing the ML model, a first artificial intelligence (AI) image of the first user, comprising an AI style, associated with the first image; and
generating a first user interface comprising the AI image of the first user, wherein the first user interface comprises indicia to enable a second user to mimic the AI style of the first AI image to apply to a second image comprising visual data indicating the second user to generate a second AI image associated with the second user.

20. The computer-readable medium of claim 19, wherein the first image comprises a profile picture of the first user and the instructions, when executed, further causes:
updating the profile picture to the first AI image.
